(19) United States
(12) Patent Application Publication
(10) Pub. No.: US 2020/0210611 A1
(43) Pub. Date: Jul. 2, 2020

(54) HARDWARE SAFE FOR PROTECTING SENSITIVE DATA WITH CONTROLLED EXTERNAL ACCESS

(71) Applicant: Konica Minolta Laboratory U.S.A., Inc., San Mateo, CA (US)

(72) Inventor: Shaun Pinney, Newark, CA (US)

(73) Assignee: Konica Minolta Laboratory U.S.A., Inc., San Mateo, CA (US)

(21) Appl. No.: 16/235,422

(22) Filed: Dec. 28, 2018

(51) Int. Cl. G06F 21/62; G06F 21/60; G06F 21/78; G06F 21/83; G06F 21/64; G06F 21/32; H04L 9/32

(52) U.S. Cl. CPC G06F 21/6245; G06F 21/6272; G06F 21/604; H04L 9/3226; G06F 21/83; G06F 21/64; G06F 21/32; G06F 21/78

(57) ABSTRACT

A method, a non-transitory computer readable medium, and a hardware device for protecting sensitive data with controlled external access. The method including: connecting a hardware safe to an external system; transferring a third-party program with an authorization policy to the hardware safe from the external system, the authorization policy configured to provide the third-party program access to one or more files and/or data fields stored on the hardware safe; executing the third-party program on the hardware safe to obtain a result in a predetermined format; and transferring the result in the predetermined format to the external system.

### FIELD OF THE INVENTION

The present disclosure generally relates to a hardware safe which uses a zero-copy security approach to reduce risks involved with sharing sensitive information between parties, and which enhances the current security landscape by enabling new options for checking sensitive data and reporting results to meet needs of all involved parties.

### BACKGROUND OF THE INVENTION

In today's security environment, sensitive data is often shared with third-parties to make use of their services. For example, a home loan applicant shares tax records, pay stubs, employment records, and other financial or personal information with mortgage lenders. Mortgage lenders use such sensitive information to judge an applicant's risk level for loan repayment before approving a loan and, more generally, that the application meets loan requirements as set forth by the mortgage lender. Normally, sensitive information is not otherwise shared except to meet certain requirements set by a third party for use of their services.

One simple observation, however, is that sharing sensitive data effectively makes a copy of the data which increases the amount of risk for the sender and receiver. The sender has effectively increased risk that the sensitive data copy is used in unauthorized ways or disclosed to unauthorized users and relinquishes control over the copy to the third-party. Additionally, the third-party must take extra steps to track and secure data to avoid unauthorized use and disclosure. Today's security breaches show that securing copies of sensitive data is not a solved problem.

Known security systems include, for example, Apple Secure Enclave and Samsung Knox technology. Apple Secure Enclave technology provides a secure software execution environment using a dedicated processor. Applications include verifying identify using fingerprint and facial recognition. Additionally, file encryption capability can be provided to protect data from external software (e.g. programs running on the main computer processing units (CPU/s)).

Samsung Knox technology provides a secure software execution environment utilizing TrustZone processor technology. Applications include file protection between applications using a secure folder and identity verification using Samsung Pass.

### SUMMARY OF THE INVENTION

In consideration of the above issues, it would be desirable to have a means for third-parties to check sensitive data without requiring a copy, and wherein third-parties can confirm that certain requirements are met to allow users access to services while reducing the security risk posed by having a copy of sensitive data.

A method is disclosed for protecting sensitive data with controlled external access, the method comprising: connecting a hardware safe to an external system; transferring a third-party program with an authorization policy to the hardware safe from the external system, the authorization policy configured to provide the third-party program access to one or more files and/or data fields stored on the hardware safe; executing the third-party program on the hardware safe to obtain a result in a predetermined format; and transferring the result in the predetermined format to the external system.

A non-transitory computer readable medium storing computer readable program code executed by a processor for protecting sensitive data with controlled external access is disclosed, the process comprising: connecting a hardware safe to an external system; transferring a third-party program with an authorization policy to the hardware safe from the external system, the authorization policy configured to provide the third-party program access to one or more files and/or data fields stored on the hardware safe; executing the third-party program on the hardware safe to obtain a result in a predetermined format; and transferring the result in the predetermined format to the external system.

A hardware device is disclosed, the hardware device comprising: a memory having personal information of a user; and a processor configured to: transferring a third-party program with an authorization policy from an external system, the authorization policy configured to provide the third-party program access to the personal information of the user stored on the memory; execute the third-party program to obtain a result in a predetermined format; and transfer the result in the predetermined format to the external system.

It is to be understood that both the foregoing general description and the following detailed description are exemplary and explanatory and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is an illustration of a system for accessing a hardware safe in accordance with an exemplary embodiment.

FIG. 2 of a computing device, which can be an external or personal computer, and can be used with the hardware safe in accordance with an exemplary embodiment.

FIG. 3 is a flow chart illustrating a process for accessing a hardware safe in accordance with an exemplary embodiment.

FIG. 4 is an illustration of a system of downloading a third-party program onto a hardware safe in accordance with an exemplary embodiment.

FIG. 5 is a flow chart illustrating a process for downloading a third-party program in accordance with an exemplary embodiment.

FIG. 6 is an illustration of a hardware safe executing a third-party program in accordance with an exemplary embodiment.

FIG. 7 is a flow chart illustrating a process of executing a third-party program on a hardware safe in accordance with an exemplary embodiment.

FIG. 8 is a chart illustrating the execution of a third-party program and authorization policy in accordance with an exemplary embodiment.

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

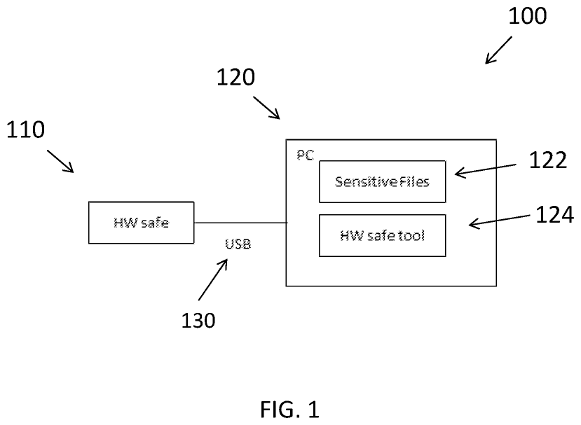

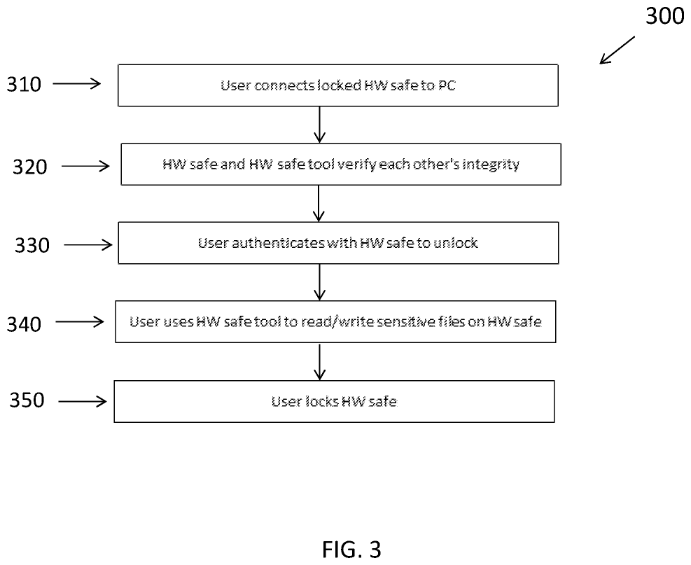

FIG. 1 is an illustration of a system 100 for accessing a hardware safe 110 in accordance with an exemplary embodiment. As shown in FIG. 1, the hardware safe (or hardware safe device) 110 can be connected to a computing device (or personal computer) 120 via a connection 130, for example, a USB connection. In accordance with an exemplary embodiment, the computing device (or personal computer) 120 can include a one or more sensitive files 122, and a hardware safe tool configured to transfer the one or more sensitive files 122 from the computing device 120 to the hardware safe 110 as shown, for example, in FIG. 3. The one or more sensitive files 122 can be, for example, any unwarranted disclosure including personal information on privacy or welfare of an individual, trade secrets of a business or a governmental entity that can be transferred to the hardware safe 110 as disclosed herein. In accordance with an exemplary embodiment, for example, the hardware safe 110 is a memory stick or USB flash drive (i.e., thumb drive), with an optional biometric security, for example, a thumbprint.

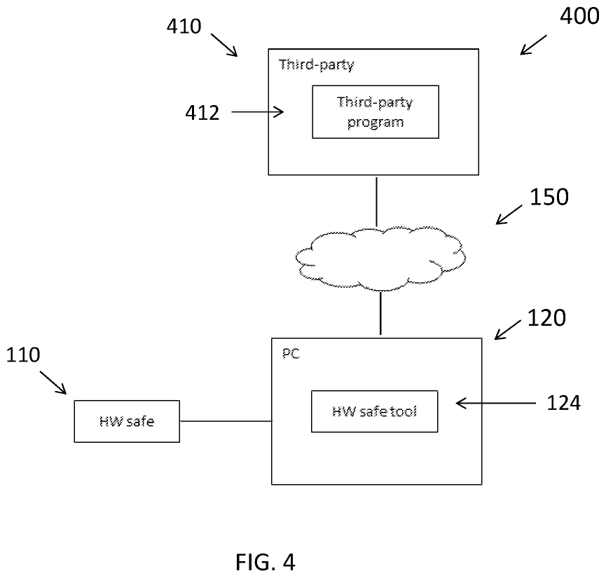

In accordance with an exemplary embodiment, users can store their sensitive data in files in a secure intelligent hardware safe 110, and can authorize a third-party application (or third-party program) 412 (FIG. 4) to run on the hardware safe 110 for reading sensitive data from the files, and return a particular result that will be transferred to the third-party 410 (FIG. 4). In accordance with an exemplary embodiment, for example, for security, the user does not authorize the result from the running of the third-party application to contain (or generate) a copy of the data. Instead, the user simply authorizes the third-party to indicate if the third party requirement is met or not met (for example, a binary result), to provide a small numeric value, or other suitable data transformation option to limit information disclosure.

In accordance with an exemplary embodiment, once the third-party application is transferred to the hardware safe 110 and executed, the third-party application 412 can then access the sensitive data and perform any calculations against the sensitive data to generate a result, and output the result. In accordance with an exemplary embodiment, the files can be in a format known to the third-party program 412 for extracting data (for example, Portable Document Format (PDF) or database with predefined fields).

In accordance with an exemplary embodiment, to avoid unauthorized access to the hardware safe 110, the files on the hardware safe may only be accessed after an authentication process to verify the owner's identity. Such an authentication process may involve security techniques such as multi-factor authentication using a variety of authentication methods (e.g. password, biometric, personal identification number (PIN), etc.), and identity verification between third party 412, user, and hardware device 110 using certificate-based verification or other mechanisms (e.g. zero-trust).

In accordance with an exemplary embodiment, to allow the third-party application 412 to run on the hardware safe (or device) 110 and to detect tampering of the execution environment (for example, to send incorrect results), technologies such as Oracle's Java Card may be used. In addition, for example, to allow the third-party application 412 to detect forged documents, the files may be obtained from and digitally signed by a third party (for example, Internal Revenue Service (IRS)) for authenticity and verified by the third-party application using public keys embedded with the application (for example, IRS public key). Additional known verification mechanisms can be included to help ensure state-of-the-art protection is provided.

In accordance with an exemplary embodiment, to help prevent the third-party application 412 from accessing unnecessary sensitive data within the safe, the user may use access control techniques such as ACLs (access control lists) to restrict data access to only allowed files and/or allowed data fields.

In accordance with an exemplary embodiment, the hardware safe 110 can be implemented as a device without a wireless network connection to enable additional physical security options for the hardware safe 110 (for example, USB removal). Thus, the hardware safe 110 is configured such that the hardware safe 110 does not have an ability to connect to a resource (or resources) including the third-party or third-party program using Uniform Resource Identifiers (URL). For example, in accordance with an exemplary embodiment, in this type of system, an external PC 120 provide a means to transfer the third-party application to the hardware safe (or device) 110.

In accordance with an exemplary embodiment, a program (i.e., the hardware safe tool) 124 running on an external PC 120 can be used to manage the hardware safe (or device) 110, for example, by managing device users (for example, enrollment), supporting authentication mechanisms (for example, input username/password, managing secure files, managing authorization setting, verifying software integrity, verifying identities, etc.)

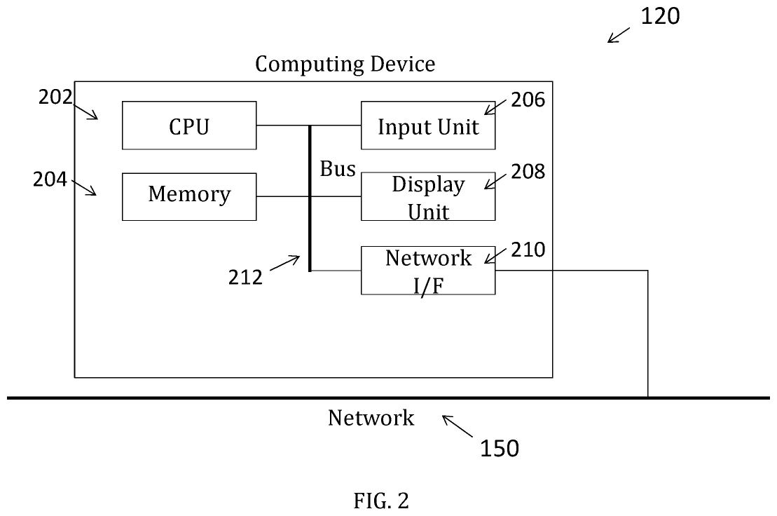

FIG. 2 is an illustration of an external computing device 120, which can be a personal computer, and can be used with the hardware safe 110 in accordance with an exemplary embodiment. As shown in FIG. 2, the exemplary computing device 120 can be an external computing device that include a processor or central processing unit (CPU) 202, and one or more memories 204 for storing software programs and data (such as files to be printed). The processor or CPU 202 carries out the instructions of a computer program, which operates and/or controls at least a portion of the functionality of the computing device 200. The computing device 200 can also include an input unit 206, a display unit or graphical user interface (GUI) 208, and a network interface (I/F) 210, which is connected to a communication network (or network) 150. A bus 212 can connect the various components 202, 204, 206, 208, 210 within the computing device 200.

In accordance with an exemplary embodiment, the computing device 200 can include a display unit or graphical user interface (GUI) 208, which can access, for example, a web browser (not shown) in the memory 204 of the computing device 200. The computing device 200 also includes an operating system (OS), which manages the computer hardware and provides common services for efficient execution of various software programs. In accordance with an exemplary embodiment, the OS of the CPU 202 is a Linux or Windows® based operating system. The software programs can include, for example, application software and printer driver software.

FIG. 3 is a flow chart 300 illustrating a process for accessing a hardware safe 110 in accordance with an exemplary embodiment. As shown in FIG. 3, in step 310, a user connects the locked hardware safe 110 to the computing device 120, via a connector 130, for example, a USB connector. In accordance with an exemplary embodiment, the connector is preferably a USB connector, for example, a cable or wire. In step 320, the hardware safe 120 and the hardware safe tool 124 verify each other's integrity. In step 330, the user authenticates with the hardware safe 110 to unlock. In step 340, the user uses the hardware safe tool to read/write sensitive files on the hardware safe 110. In step 350, the user locks the hardware safe 110.

In accordance with an exemplary embodiment, in addition to the steps shown in FIG. 3, the hardware safe 110 can authenticated with the hardware safe tool 124, and/or an external cloud server can be used for one or more of the steps 320, 330, for example, verifying the integrity of the hardware safe and the hardware safe tool 124. In accordance with an exemplary embodiment, the user authentication as shown in step 330 can be include, for example, a biometric authentication, a multi-factor authentication, for example, biometric and personal identification number (PIN). The authentication, for example, can include one or more of the following: fingerprint, facial identification or facial recognition, and/or iris detection, and/or username and PIN (personal identification number). In addition, the verification (step 320) of the hardware safe 110 and the hardware safe tool 124 verifying each other's integrity can be optional, and may or may not be performed.

FIG. 4 is an illustration of a system 400 of downloading a third-party program 412 onto the hardware safe 110 in accordance with an exemplary embodiment. As shown in FIG. 4, the system 400 can include a third-party 410, for example, a financial institution or mortgage company, and wishes to access the sensitive information contained on the hardware safe 110 for one or more reasons. The third-party 410, for example, can include a computing device 120 as shown in FIG. 2 having a third-party program 412, which is configured to access the information on the hardware safe 110 and generate a result as disclosed herein. In accordance with an exemplary embodiment, the third-party program 412 can be, for example, for verifying employment and financials for a home loan or car loan. The third-party 410 being connected to the computing device 120, for example, by a communication network or network 150, and wherein the computing device 120 is connected to the hardware safe 110.

In accordance with an exemplary embodiment, the communication network or network 150 can be a public telecommunication line and/or a network (for example, LAN or WAN). Examples of the communication network 150 can include any telecommunication line and/or network consistent with embodiments of the disclosure including, but are not limited to, telecommunication or telephone lines, the Internet, an intranet, a local area network (LAN) as shown, a wide area network (WAN) and/or a wireless connection using radio frequency (RF) and/or infrared (IR) transmission.

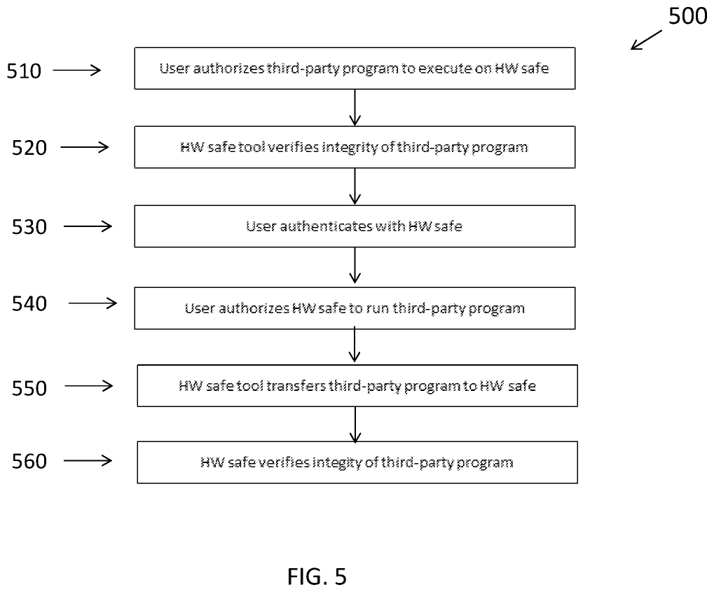

FIG. 5 is a flow chart 500 illustrating a process for downloading a third-party program 412 in accordance with an exemplary embodiment. As shown in FIG. 5, in step 510, the user authorizes the third-party program 412 to execute on the hardware safe 110. In accordance with an exemplary embodiment, the authorization of the third-party program by the user may be through or with the hardware safe tool 124. In step 520, the hardware safe tool 124 verifies the integrity of the third-party program 412. In accordance with an exemplary embodiment, the verification of the third-party program 412 can be performed with an external server, for example, an external cloud server. Alternatively, the verification of the third-party program can be optional and/or not performed. In step 530, the user authenticates with the hardware safe. In step 540, the user authorizes the hardware safe to run the third-party program. In step 550, the hardware safe tool transfers the third-party program to the hardware safe. In step 560, the hardware safe verifies the integrity of the third-party program.

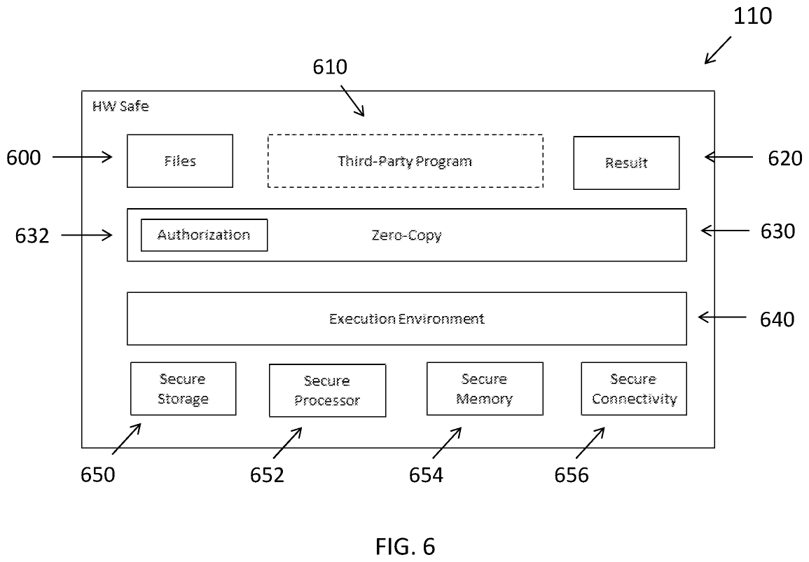

FIG. 6 is an illustration of a hardware safe 110 executing a third-party program 610 in accordance with an exemplary embodiment. As shown in FIG. 6, the hardware safe 110 includes files 600, the third-party program 610, a result module (or program) 620, a zero-copy module 630 having an authorization module 632, an execution environment 640, a secure storage module 650, a secure processor 652, a secure memory 654, and secure connectivity module 656.

As shown in FIG. 6, the hardware safe 110 includes a plurality of files 600, each of the plurality of files 600 can include sensitive or personal information (or sensitive data) of the owner of the hardware safe 110. For example, the files 600 can include any information that a user which to keep from unwarranted disclosure including personal information on privacy or welfare of an individual, trade secrets of a business or a governmental entity. In accordance with an exemplary embodiment, the sensitive information can include social security number (SSN) or social insurance number (SIN) issued in the United States and Canada, respectively, credit card numbers, financial information of the user including bank accounts or bank statements, stocks, real estate and other financial holdings, pay checks, employment history, and/or tax returns. In addition, the sensitive information can include records of a user's health care, education, and employment that may be protected by privacy laws. In accordance with an exemplary embodiment, the sensitive information or data can be that of a business, for example, trade secrets, sales and marketing plants, notes associated with patentable inventions, customer and supplier information, financial data and/or classified information.

In accordance with an exemplary, the third-party program 610 is a program configured to access one or more of the plurality of files 600 on the hardware safe 110 for determination of a result. In accordance with an exemplary embodiment, the third-party program 610 does not copy any of the plural of files 600 on the hardware safe 110 (i.e., a zero-copy policy). The third-party program 610 executes a program configured to generate a result, which indicate if the third party requirement is met or not met (for example, a binary result), to provide a small numeric value, or other suitable data transformation option which does not disclose the confidential information. In accordance with an exemplary embodiment, the third-party program 610 is external code running in hardware safe. The dashed lines around the third-party program 610 indicates that the third-party program is an external module, which is not part of the core of the hardware safe 110.

In accordance with an exemplary embodiment, the hardware safe 110 has a zero-copy module (or zero-copy security) 630, which is configured to allow the third-party program 610 access (or authorization 632) to only those files of the plurality of files 600 that the third-party program 610 needs to access for the purposes of executing the program for the desired result. For example, the zero-copy module 630 restricts the third-party program 610 to access to the secure storage and connectivity so that only authorized files and/or data fields may be accessed and only allowed results may be supplied externally via connectivity. Accordingly, the plurality of files 600 may include one or more files that are not accessible or available to the third-party program 610 as a result of the authorization policy 632 of the zero-copy module 630.

In accordance with an exemplary embodiment, the execution of the third-party program 610 is performed on the hardware safe 110 in an execution environment 640 such that none of the sensitive data (or files) 600 leaves the hardware safe during the execution of the third-party program 610. In accordance with an exemplary embodiment, the execution environment 640 may be Java Card or other environment allowing execution of external code.

The hardware safe 110 also includes a secure storage 650. In accordance with an exemplary embodiment, the secure storage 650 may be dedicated flash memory or other storage technology, optionally with security extensions such as encryption. The secure processor 652 may be a dedicated ARM processor or other central processing unit (CPU), optionally with security extensions such as TrustZone and device-specific key generation for encryption. The secure memory 654 may be, for example, dedicated DDR or other memory, optionally with security extensions such as encryption. The secure connectivity 656 may be USB or other communication technology, optionally with security extensions such as encryption. In accordance with an exemplary embodiment, the secure connectivity 656 may be USB or other communication technology, optionally with security extensions such as encryption.

In accordance with an exemplary embodiment, the zero-copy policy of the hardware safe 110 may rely upon special-purpose hardware, for example, in the secure connectivity 656, to ensure any results sent to an external system meet the conditions of the authorization policy and that the result has been verified before the result is sent. For example, the special-purpose hardware in the secure connectivity (module) 656 can send a request to the third-party program 610 to verify that the result to be sent by the special-purpose hardware is the same result that was generated by the third-party program and has not been modified. In accordance with an exemplary embodiment, if the result is correct, the third-party program can certify the result by generating, for example, a digital signature for the result, prior to the secure connectivity 656 sending the result to the external system, then supply the digital signature to the secure connectivity 656, where the security connectivity 656 will send the result and digital signature to the external system, for example, system 400.

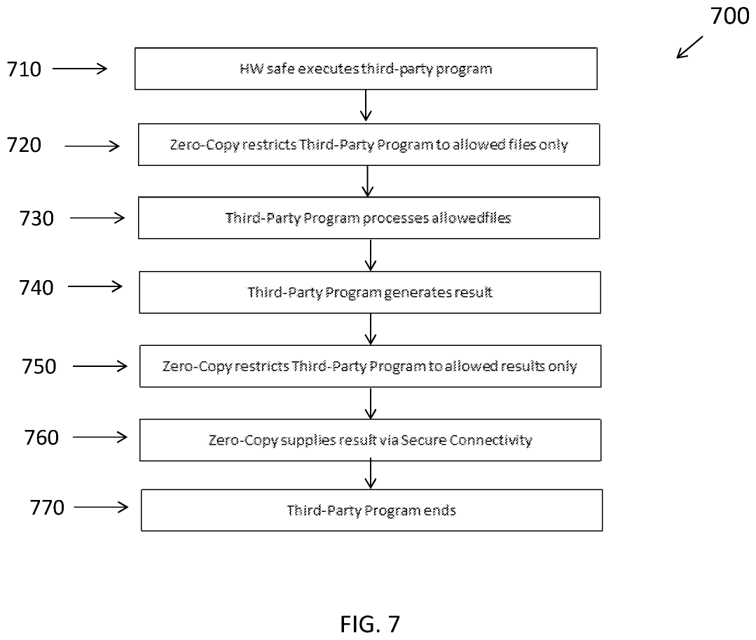

FIG. 7 is a flow chart 700 illustrating a process of executing a third-party program 610 on the hardware safe 110 in accordance with an exemplary embodiment. As shown in FIG. 7, in step 710, the hardware safe executes the third-party program 610. In step 720, the zero-copy module 630 restricts the third-party program to allowed files and/or data fields only. In step 730, the third-party program processes allowed files. In step 740, the third-party program generates results, which are sent to the result module 620. In accordance with an exemplary embodiment, the result generated by the third-party program is preferably transferred to the computing device 120 to be displayed, for example, on the display unit 208, or sent to printer for printing such that the third-party may see the results. In step 750, the zero-copy restricts third party program to allowed results only. In step 760, the zero-copy supplies results via the secure connectivity module 656, and in step 770, the third-party program ends.

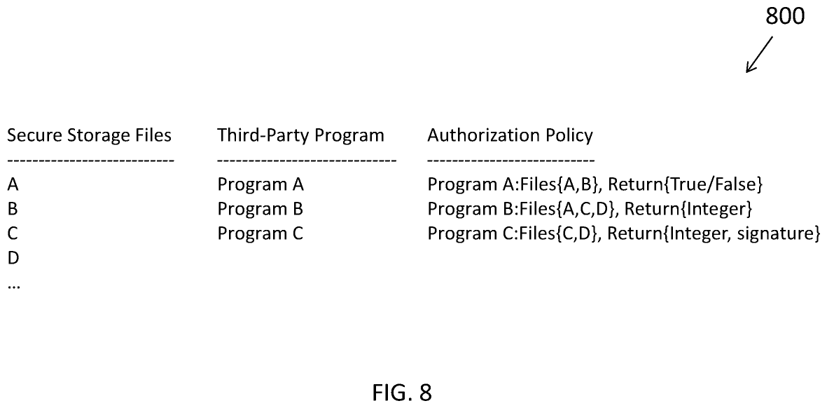

FIG. 8 is a chart 800 illustrating the execution of a third-party program and authorization policy in accordance with an exemplary embodiment. As shown in FIG. 8, for example, the authorization policy shows that Program A is authorized to read files A and B, and return a “True” or “False” result. In addition, the authorization policy shows that the Program B is authorized to read files A, C, and D, and return an integer (or numerical) result. In accordance with a further example, for example, in Program C, the authorization policy can be that only files C and D can be read, and the result is an integer (or numerical) result and a signature (for example, a digital signature). In accordance with an exemplary embodiment, the file and return policies can be configured to meet requirements of a specific program, for example, allow write access, and return type defined by the third party program.

In accordance with an exemplary embodiment, the methods and processes as disclosed can be implemented on a non-transitory computer readable medium. The non-transitory computer readable medium may be a magnetic recording medium, a magneto-optic recording medium, or any other recording medium which will be developed in future, all of which can be considered applicable to the present invention in all the same way. Duplicates of such medium including primary and secondary duplicate products and others are considered equivalent to the above medium without doubt. Furthermore, even if an embodiment of the present invention is a combination of software and hardware, it does not deviate from the concept of the invention at all. The present invention may be implemented such that its software part has been written onto a recording medium in advance and will be read as required in operation.

As used herein, an element or step recited in the singular and preceded by the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional examples that also incorporate the recited features.

The patent claims at the end of this document are not intended to be construed under 35 U.S.C. § 112(f) unless traditional means-plus-function language is expressly recited, such as “means for” or “step for” language being expressly recited in the claim(s).

It will be apparent to those skilled in the art that various modifications and variation can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for protecting sensitive data with controlled external access, the method comprising:
connecting a hardware safe to an external system;
transferring a third-party program with an authorization policy to the hardware safe from the external system, the authorization policy configured to provide the third-party program access to one or more files and/or data fields stored on the hardware safe;
executing the third-party program on the hardware safe to obtain a result in a predetermined format; and
transferring the result in the predetermined format to the external system.

2. The method according to claim 1, wherein the hardware safe does not have an ability to connect to a resource using Uniform Resource Identifiers (URL).

3. The method according to claim 1, wherein the one or more files and/or data fields contain personal information on a user.

4. The method according to claim 1, wherein the external system includes a hardware safe tool, the hardware safe tool configured to perform one or more of the following:
transfer the one or more files and/or data fields to the hardware safe;
transfer the third-party program to the hardware safe;
transfer the authorization policy for the third-party program to the hardware safe; and
transfer the result from the hardware safe to the third-party.

5. The method according to claim 4, further comprising:
verifying an integrity of the third-party program with the hardware safe tool before the execution of the third-party program on the hardware safe.

6. The method according to claim 1, further comprising:
encrypting the one or more files and/or data fields on the hardware safe.

7. The method according to claim 1, further comprising:
authenticating a user and the one or more files and/or data fields of the user on the hardware safe, the authenticating of the user and the one or more files and/or data fields of the user on the hardware safe being performed by biometrics and/or a personal identification number (PIN) for the user and by personal authentication by the user or by authentication of an entity producing the one or more files and/or data fields and validating an integrity of the one or more files and/or data fields.

8. The method according to claim 4, wherein the external system comprises:
hosting the hardware safe tool in an external computer, the external computer and the hardware safe being in communication via a USB connection; and
hosting the third-party program on a third-party computer in communication with the external computer via a communication network.

9. A non-transitory computer readable medium storing computer readable program code executed by a processor for protecting sensitive data with controlled external access, the process comprising:
connecting a hardware safe to an external system;
transferring a third-party program with an authorization policy to the hardware safe from the external system, the authorization policy configured to provide the third-party program access to one or more files and/or data fields stored on the hardware safe;
executing the third-party program on the hardware safe to obtain a result in a predetermined format; and
transferring the result in the predetermined format to the external system.

10. The non-transitory computer readable medium according to claim 9, wherein the hardware safe does not have an ability to connect to a resource identified using Uniform Resource Identifiers (URL).

11. The non-transitory computer readable medium according to claim 9, wherein the external system includes a hardware safe tool, the hardware safe tool configured to perform one or more of the following:
transfer the one or more files and/or data fields to the hardware safe;
transfer the third-party program to the hardware safe;
transfer the authorization policy for the third-party program to the hardware safe; and
transfer the result from the hardware safe to the third-party.

12. The non-transitory computer readable medium according to claim 11, further comprising:
verifying an integrity of the third-party program with the hardware safe tool before the execution of the third-party program on the hardware safe;
encrypting the one or more files and/or data fields on the hardware safe; and
authenticating a user and the one or more files and/or data fields of the user on the hardware safe, the authenticating of the user and the one or more files and/or data fields of the user on the hardware safe being performed by biometrics and/or a personal identification number (PIN) for the user and by personal authentication by the user or by authentication of an entity producing the one or more files and/or data fields and validating an integrity of the one or more files and/or data fields.

13. The non-transitory computer readable medium according to claim 11, wherein the external system comprises:
hosting the hardware safe tool in an external computer, the external computer and the hardware safe being in communication via a USB connection; and
hosting the third-party program on a third-party computer in communication with the external computer via a communication network.

14. A hardware device, the hardware device comprising:
a memory having personal information of a user; and
a processor configured to:
transferring a third-party program with an authorization policy from an external system, the authorization policy configured to provide the third-party program access to the personal information of the user stored on the memory;
execute the third-party program to obtain a result in a predetermined format; and
transfer the result in the predetermined format to the external system.

15. The hardware device according to claim 14, wherein the personal information of the user is encrypted in the memory of the hardware device.

16. The hardware device according to claim 14 wherein the external system includes a hardware safe tool, the hardware safe tool configured to perform one or more of the following:
transfer the personal information of the user to the hardware device;
transfer the third-party program to the hardware device;
transfer the authorization policy for the third-party program to the hardware device; and
transfer the result from the hardware device to the third-party.

17. The hardware device according to claim 14, wherein the hardware device is a memory stick, the memory stick configured to be connected to the external system via a USB connection.

18. The hardware device according to claim 14, wherein the personal information of the user is stored in the memory of the hardware device in Portable Document Format (PDF) with predefined fields.

19. The hardware device according to claim 18, wherein a user and the personal information of the user on the hardware device are authenticated, the authenticating of the user and the personal information of the user on the hardware safe being performed by biometrics and/or a personal identification number (PIN) for the user and by personal authentication by the user or by authentication of an entity producing the personal information of the user and validating an integrity of the personal information.

20. The hardware device according to claim 16, wherein the external system comprises:
an external computer configured to host the hardware safe tool, the external computer and the hardware device being in communication via a USB connection; and
a third-party computer in communication with the external computer via a communication network, the third-party program configured to host the third party program.
